(19) United States
(12) Patent Application Publication
(10) Pub. No.: US 2017/0140365 A1
(43) Pub. Date: May 18, 2017

(54) SYSTEMS AND METHODS USING CHECK DOCUMENT IMAGES TO CREATE PRE-PAID PAYMENT CARDS

(71) Applicant: MasterCard International Incorporated, Purchase, NY (US)

(72) Inventors: Siddique HAMEED, Chesterfield, MO (US); Jeffrey T SIGMON, St. Louis, MO (US)

(21) Appl. No.: 14/941,940

(22) Filed: Nov. 16, 2015

(51) Int. Cl. G06Q 20/28; G06F 17/30

(52) U.S. Cl. CPC G06Q 20/28; G06F 17/30268; G06F 17/30106; G06F 17/30091

(57) ABSTRACT

According to some embodiments, an electronic image file associated with a check document and a drawer party identifier may be received from a remote drawer party device and information about the electronic image file may be stored into a check image database. A banking transaction server may retrieve the information about the electronic image file and drawer party identifier from the check image database and automatically determine supplemental information associated with the banking transaction. The banking transaction server may then transmit a signal to facilitate a delivery of a pre-paid payment token to a payee party associated with the banking transaction.

### BACKGROUND

A person can go to a merchant to purchase a pre-paid payment card. For example, a person might visit a drugstore and purchase a $50.00 pre-paid debit card using cash, a credit card, or a debit card associated with his or her bank account. He or she can then give the pre-paid payment card to another party (e.g., as a gift, to repay a debt, in exchange for a product or service, etc.). Visiting a merchant, however, may be an inconvenient and time consuming process. Moreover, some people might not have a debit card that can be used to withdraw funds from a bank account.

It would therefore be desirable to provide accurate and efficient systems and methods to facilitate a transfer of funds from a bank checking account to a pre-paid payment card that can be provided to another party.

### BRIEF DESCRIPTION OF THE DRAWINGS

FIG. 1 is a high level flow diagram of a banking transaction process in accordance with some embodiments.

FIG. 2 is a block diagram overview of a system according to some embodiments of the present invention.

FIG. 3 illustrates a banking transaction method that might be performed in accordance with some embodiments.

FIGS. 4 through 7 illustrate banking transaction examples according to some embodiments.

FIG. 8 is block diagram of a banking transaction tool or platform according to some embodiments of the present invention.

FIG. 9 is a tabular portion of a check image database according to some embodiments.

FIG. 10 illustrates a smartphone banking transaction display according to some embodiments.

FIG. 11 illustrates a banking transaction portal display in accordance with some embodiments.

### DETAILED DESCRIPTION

A person can go to a merchant to purchase a pre-paid payment card. For example, a person might visit a drugstore and purchase a $50.00 pre-paid debit card using cash, a credit card, or a debit card associated with his or her bank account. He or she can then give the pre-paid payment card to another party (e.g., as a gift, to repay a debt, in exchange for a product or service, etc.). Visiting a merchant, however, may be an inconvenient and time consuming process. Moreover, some people might not have a debit card that can be used to withdraw funds from a bank account. It would therefore be desirable to provide accurate and efficient systems and methods to facilitate a transfer of funds from a bank checking account to a pre-paid payment card that can be provided to another party.

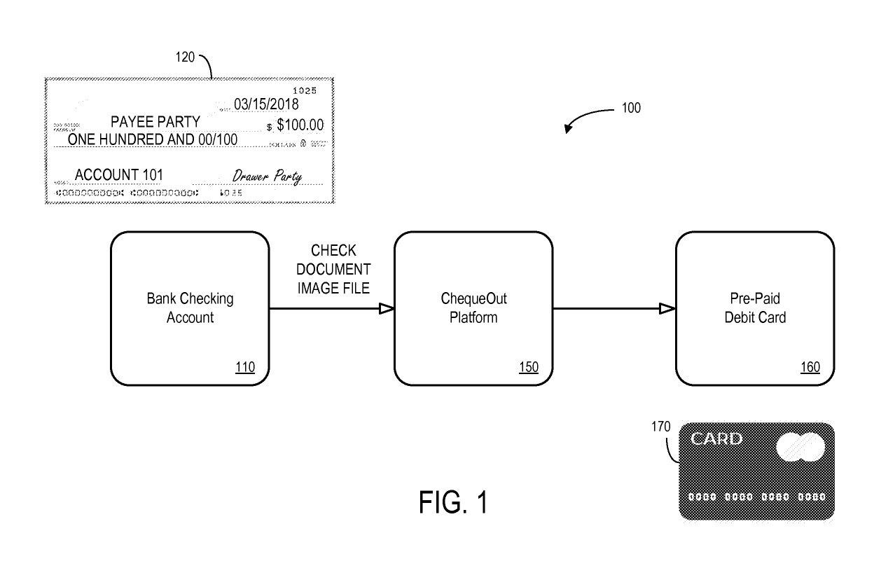

FIG. 1 is a high level flow diagram of a banking transaction process 100 in accordance with some embodiments. In particular, a person with a bank checking account 110 may write a paper check document 120, including a payee part, a check amount, a check date, and or a check description (e.g., explaining a purpose of the particular bank check). He or she may then transmit an electronic image file of the check document 120 to a remote “ChequeOut Platform” 150. For example, the person might take a picture of the check document 120 using his or her smartphone and then execute an application on the smartphone to transmit the image file to the remote ChequeOut platform 150. The ChequeOut platform 150 may then arrange to issue a pre-paid debit card 160 to the payee party (e.g., by mailing a physical pre-paid debit card 170 to a postal address of the payee party. In this way, the person who wrote the check document 120 can transfer funds from his or her bank checking account 110 to the payee party.

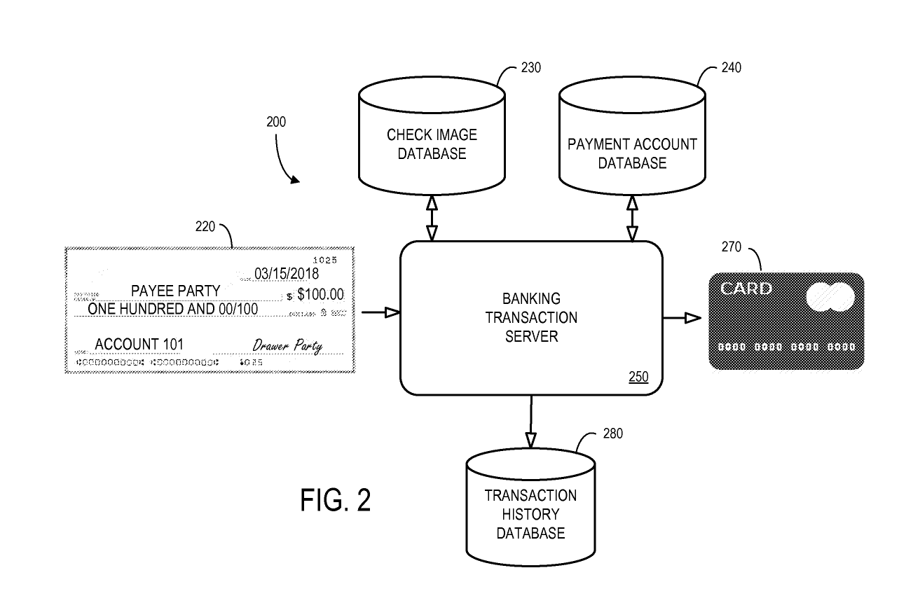

The process 100 of FIG. 1 might be performed in connection with a number of different hardware arrangements. For example, FIG. 2 is block diagram of a system 200 according to some embodiments of the present invention. In particular, the system 200 includes a banking transaction server 250 that receives an electronic image file of a check document 220.

The banking transaction server 250 might be, for example, associated with a Personal Computer (“PC”), laptop computer, an enterprise server, a server farm, and/or a database or similar storage devices. The banking transaction server 250 may, according to some embodiments, be associated with a bank, a credit card company, or any other party.

According to some embodiments, an “automated” banking transaction server 250 may identify a bank account owner when he or she attempts to make a transaction using the banking transaction server 250. For example, the banking transaction server 250 may automatically use Optical Character Recognition (“OCR”) software to detect a bank account owner (e.g., the drawer party who wrote the check document). As used herein, the term “automated” may refer to, for example, actions that can be performed with little (or no) intervention by a human.

As used herein, devices, including those associated with the banking transaction server 250 and any other device described herein, may exchange information via any communication network which may be one or more of a Local

Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN, and/or an Internet Protocol (“IP”) network such as the Internet, an intranet, or an extranet. Note that any devices described herein may communicate via one or more such communication networks.

The banking transaction server 250 may retrieve data from a check image database 230 and/or a payment account database 240. The payment account database 240 might be associated with, for example, payment accounts such as bank accounts. The check image database 230 and the payment account database 240 may be locally stored or reside remote from the banking transaction server 250. As will be described further below, the check image database 230 and payment account database 240 may be used by the banking transaction server 250 to generate and/or transmit a pre-paid payment card 270. According to some embodiments, the banking transaction server 250 communicates information to an external device, such as by transmitting an electronic file to an email server, a workflow management system, POS device, etc. In other embodiments, the banking transaction server 250 might store transaction information in a transaction history database 280.

Although a single banking transaction server 250 is shown in FIG. 2, any number of such devices may be included. Moreover, various devices described herein might be combined according to embodiments of the present invention. For example, in some embodiments, the banking transaction server 250, check image database 230 and/or payment account database 240 might be co-located and/or may comprise a single apparatus.

In accordance with some embodiments, the systems and methods described herein provide a framework to create pre-paid payment cards 270. By way of example, and without limiting the generality of the foregoing, a pre-paid payment card 270 might be associated with a debit account or any other type of financial transaction account in which funds may be stored. Further, as used herein in, the term “issuer” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction” can be associated with, for example, a merchant, a merchant terminal, an online account, or any other suitable institution or device configured to initiate a financial transaction per the request of an account owner.

The information in the payment account database 240 may be associated with, for example, a banking network, a “payment card processing system” or “credit card processing networks,” such as the MasterCard® network that allows account owners to use payment cards issued by a variety of issuers to shop at a variety of merchants. With this type of payment card, a card issuer or attribute provider, such as a bank, extends credit to an account owner to purchase products or services. When an account owner makes a purchase from an approved merchant, or withdraws funds via an ATM, the card number and amount of the purchase, along with other relevant information, are transmitted via the processing network to a processing center, which verifies that the card has not been reported lost or stolen and that the card's credit limit has not been exceeded. In some cases, the account owner's signature is also verified, a personal identification number is required or other user authentication mechanisms are imposed. The account owner is required to repay the bank for the purchases or cash withdrawals, generally on a monthly basis.

The payment account database 240 may further store a “business classification,” which is a group of merchants and/or businesses, by the type of goods and/or service the merchant and/or business provides. For example, the group of merchants and/or businesses can include merchants and/or business, which provide similar goods and/or services. In addition, the merchants and/or businesses can be classified based on geographical location, sales, and any other type of classification, which can be used to associate a merchant and/or business with similar goods, services, locations, economic and/or business sector, industry and/or industry group. According to some embodiments, different business classifications may be associated with different biometric standards.

The payment account database 240 may also store a “merchant category code” or “MCC,” which is a four-digit number created by MasterCard® or VISA® and assigned to a business by the acquirer when the business first starts accepting one of these cards as a form of payment. The MCC is used to classify the business by the type of goods or services it provides. For example, in the United States, the merchant category code can be used to determine if a payment needs to be reported to the IRS for tax purposes. In addition, MCCs are used by card issuers to categorize, track or restrict certain types of purchases. According to some embodiments, different MCCs may be associated with different biometric standards.

In accordance with some embodiments, data associated with payment card transactions is stored within the transaction history database 280. The data may include, for example, a listing of sales amount for each payment card transaction including the a transaction date, transaction amount, drawer party identifier, payee party identifier, a type of pre-paid payment card, delivery instructions etc.

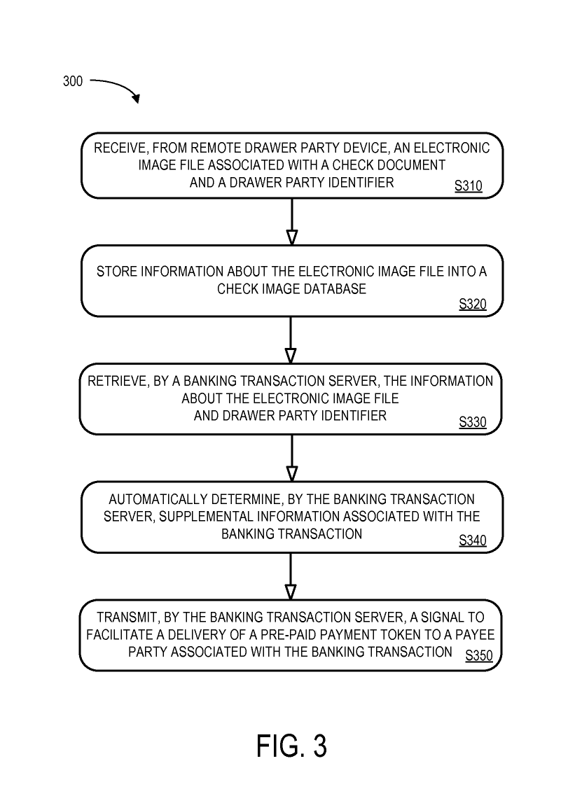

FIG. 3 illustrates a banking transaction method 300 that might be performed by some or all of the elements of the system 200 described with respect to FIG. 2 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S310, a banking transaction server may receive, from a remote drawer party device, an electronic image file associated with a check document and a “drawer party” identifier. As used herein, the phrase “drawer party” refers to the person who signed the check document (e.g., the person providing payment). The remote drawer party device might be associated with, for example, a smartphone, a camera, a scanner, a web camera, a facsimile machine and/or a copier.

At S320, information about the electronic image file may be stored into a check image database, the check image database storing, for each of a plurality of banking transactions, information about the electronic image file and the drawer party identifier. At S330, a banking transaction server may retrieve, from the check image database, the information about the electronic image file and drawer party identifier.

At S340, the banking transaction server may automatically determine supplemental information associated with the banking transaction. The automatically determined supplemental information might include, for example, a drawer party postal address, a drawer party bank account number, a check amount, a check date, a check description, a payee party name (i.e., the person receiving the funds from the drawer party), a payee party postal address, a payee party electronic message address, a payee party bank account number, a payment type, and a payment delivery type.

At S350, the banking transaction server may transmit a signal to facilitate a delivery of a pre-paid payment token to a payee party associated with the banking transaction. As used herein, the phrase “pre-paid payment token” might refer to, for example, a pre-paid debit card (e.g., a physical or virtual pre-paid debit card) or any other device or account able to store funds. Note that according to some embodiments the payee party may be the same as the drawer party. That is, a person might write a check payable to himself or herself and then use that check to receive a pre-paid debit card.

According to some embodiments, the pre-paid payment token is associated with a physical pre-paid payment card that will be mailed to a payee party postal address. According to other embodiments, the pre-paid payment token is associated with a physical pre-paid payment card that will be picked-up by the payee party. For example, the payee party might be instructed to visit his local drugstore to pick up a pre-paid debit card (and the ChequeOut Platform will automatically arrange with the merchant to have a valid pre-paid debit card waiting there for the appropriate amount of funds). In other embodiments, the pre-paid payment token might comprise a physical pre-paid payment card delivered to a payee party postal address via a delivery service. For example, an Uber driver might have a device installed in his or her car that automatically creates pre-paid debit cards (for an appropriate amount of funds) along with instructions regarding where the card should be delivered. Some or all of this function may be implemented via Application Programming Interfaces (“APIs”). Note that the pre-paid payment token might be associated with a Primary Account Number (“PAN”), an expiration date, and/or a Card Security Code (“CSC”).

Instead of a physical payment card, some embodiments described herein may be associated with a creation of a “virtual” pre-paid payment token. For example, the pre-paid payment token might be associated with a virtual pre-paid payment card delivered via a payment portal (e.g., associated with a ChequeOut web page). Other embodiments might be associated with a virtual pre-paid payment card delivered via an electronic message, such as an email message or a Simple Messaging Service (“SMS”) text message. In either case, the virtual account might be associated with a PAN, an expiration date, and/or a CSC as appropriate.

According to some embodiments, a banking transaction server might transmit signals to facilitate delivery of pre-paid payment tokens to the payee party on a periodic basis. For example, a parent might arrange for his or her child to receive $200.00 each month while attending college. In this case, the pre-paid payment token might comprise a re-usable pre-paid payment card (e.g., the same pre-paid debit card might receive funds on the first day of each month).

Note that a banking transaction server might interact with other devices and/or platform to facilitate generation of a pre-paid payment card. For example, the payee party's bank may need to pay a specific amount of money from the person's account. The person writing the check (the drawer party) may have a transaction banking account (often called a current or checking account) where the money is held. The drawer party writes the various details including the monetary amount, date, and a payee party on the check and signs it to arrange for his or her bank (known as the drawee bank) to pay the appropriate amount. Any of these steps in the transaction might involve the automatic exchange of electronic messages with the banking transaction server.

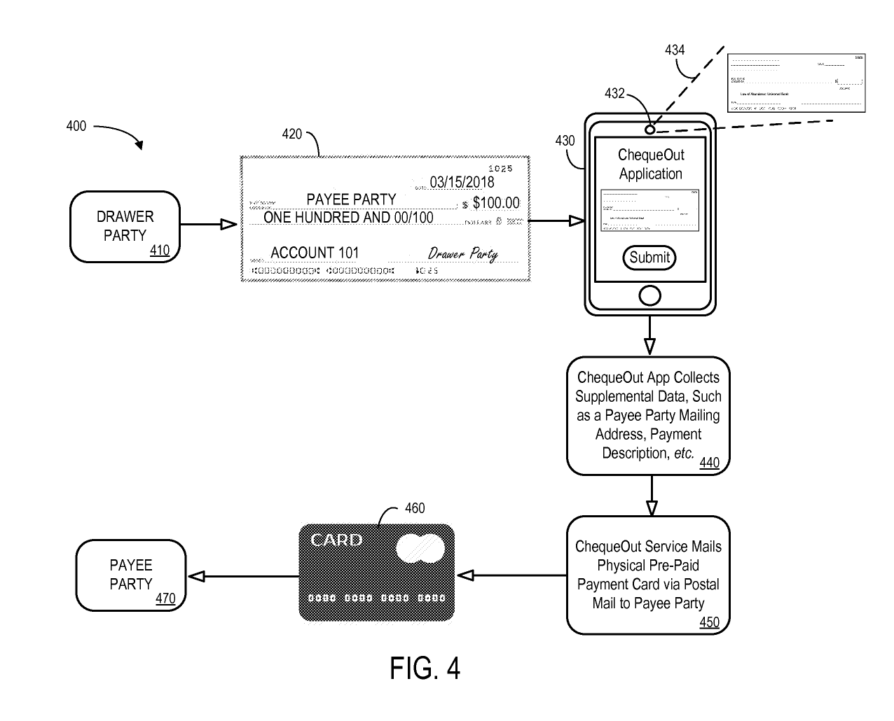

FIGS. 4 through 7 illustrate banking transaction examples according to some embodiments. In FIG. 4, for example, a drawer party 410 writes a check document 420 and uses a smartphone 430 with a camera 432 to capture an image of the check document 420 (e.g., within a field-of-view 434 of the camera 432). The smartphone 430 may transmit the image to a ChequeOut website, portal, application, or platform 440 which will collect supplemental information, such as a payee party name, a postal mailing address, a payment description, etc. A ChequeOut service 450 may then send a physical pre-paid payment card 460 (storing an appropriate amount of funds) via postal mail to the payee party 470 to complete the transaction.

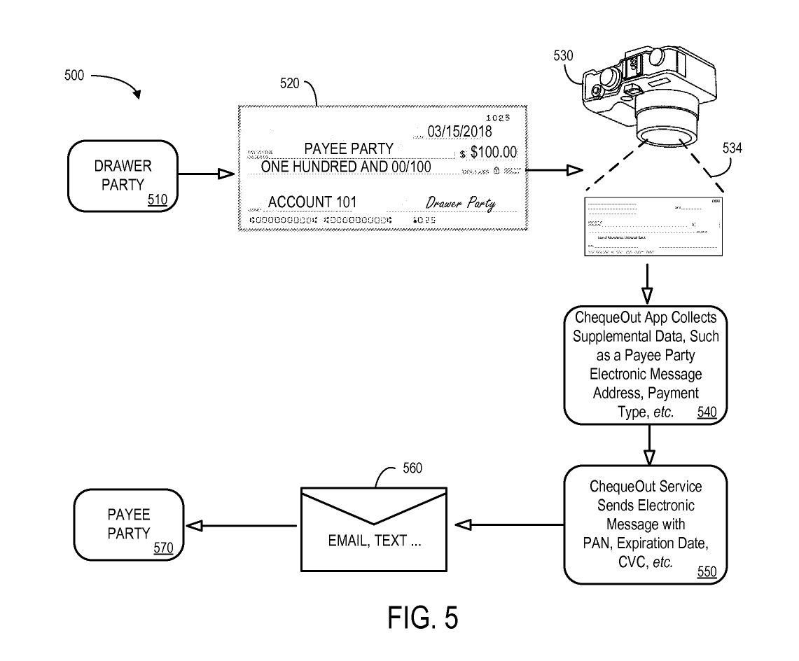

Similarly, in FIG. 5 a drawer party 510 writes a check document 520 and uses a camera 530 to capture an image of the check document 520 (e.g., within a field-of-view 534 of the camera 530). The camera 530 or some other device may then transmit the image to a ChequeOut website, portal, application, or platform 540 which will collect supplemental information, such as a payee electronic message address, a payment type, etc. A ChequeOut service 550 may then send a virtual pre-paid payment card 560 (storing an appropriate amount of funds) via an email containing the appropriate PAN, expiration date, CVC, etc. to the payee party 570 completing the transaction.

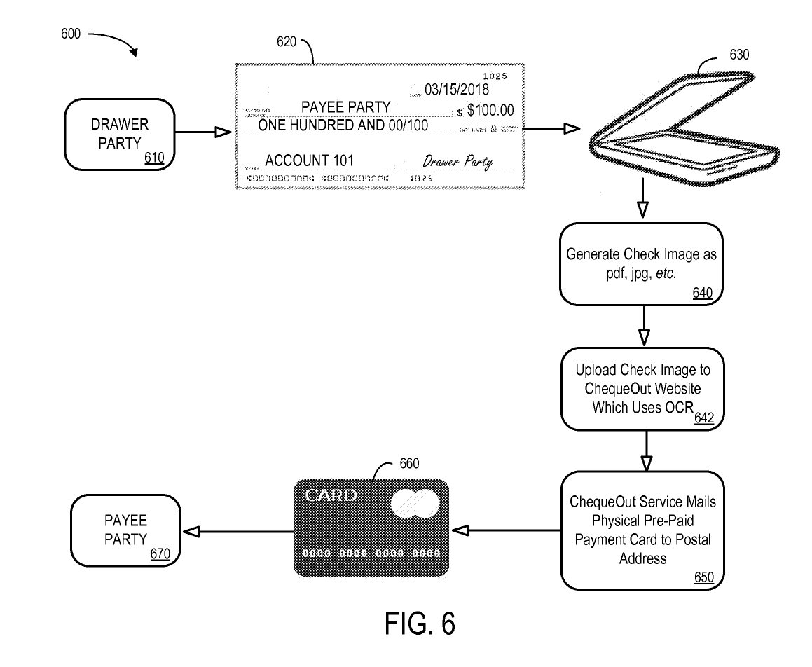

As another example, in FIG. 6 a drawer party 610 writes a check document 620 and uses a scanner to capture an image of the check document 620 (e.g., creating a check image as a jpg file, a pdf file, etc. at 640). The scanner 630 or another device may transmit the image to a ChequeOut website, portal, application, or platform which will use an OCR process to determine information about the check document 642. A ChequeOut service 650 may then send a physical pre-paid payment card 660 (storing an appropriate amount of funds) via postal mail to the payee party 670 to complete the transaction.

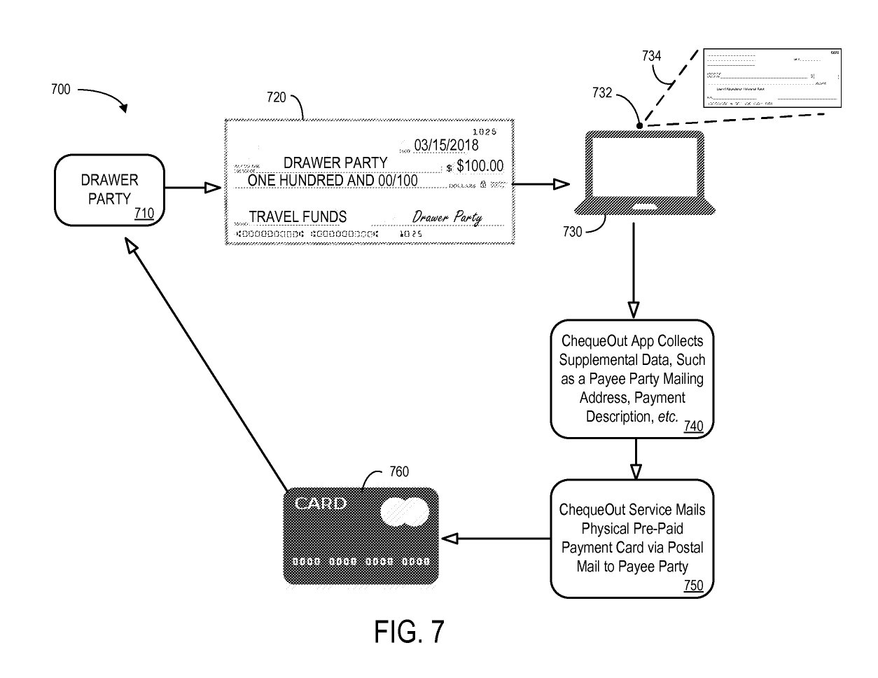

As still another example, in FIG. 7 a drawer party 710 writes a check document 720 to himself or herself (that is, the drawer party 710 is also the payee party) and uses a computer 730 with a web camera 732 to capture an image of the check document 720 (e.g., within a field-of-view 734 of the web camera 732). The computer 730 may transmit the image to a ChequeOut website, portal, application, or platform 740 which will collect supplemental information, such as a postal mailing address, a payment description, etc. A ChequeOut service 750 may then send a physical pre-paid payment card 760 (storing an appropriate amount of funds) via postal mail to the drawer party 710 (who is also the payee party) to complete the transaction. This might be useful, for example, if the drawer party 710 was planning to travel to another country and did not feel comfortable carrying checks, credit cards, debit cards, etc. curing the trip.

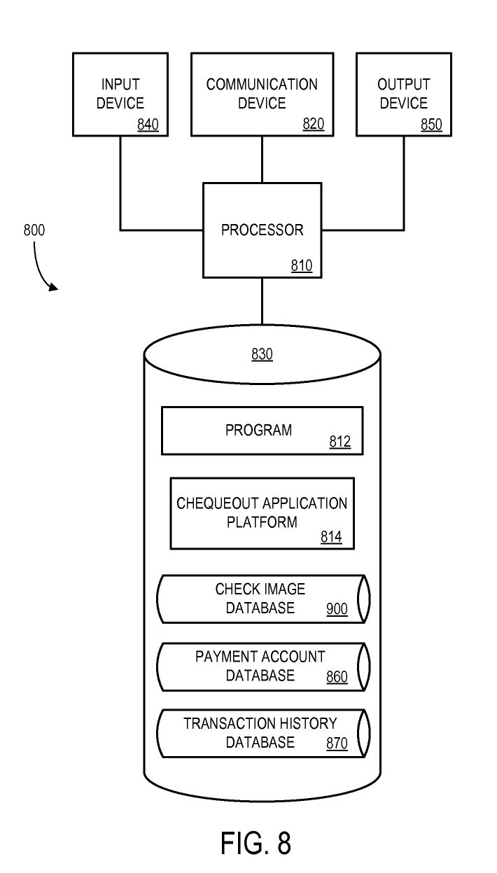

In this way, a banking transaction server may facilitate a creation of a pre-paid payment token using an image of a check document. Note that the embodiments described herein may be implemented using any number of different hardware configurations. For example, FIG. 8 illustrates a banking transaction server 800 that may be, for example, some or all of the elements associated with the systems 100, 200 of FIGS. 1 and 2. The banking transaction server 800 comprises a processor 810, such as one or more commercially available Central Processing Units (“CPUs”) in the form of one-chip microprocessors, coupled to a communication device 820 configured to communicate via a communication network (not shown in FIG. 8). The communication device 820 may be used to communicate, for example, with one or more remote drawer party devices. The banking transaction server 800 further includes an input device 840 (e.g., a computer mouse and/or keyboard to enter information about user accounts) and an output device 850 (e.g., a computer monitor or printer to output active user or transaction reports).

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 812 and/or ChequeOut application platform logic 814 for controlling the processor 810. The processor 810 performs instructions of the programs 812, 814, and thereby operates in accordance with any of the embodiments described herein. For example, an electronic image file associated with a check document and a drawer party identifier may be received by the processor 810 from a remote drawer party device and information about the electronic image file may be stored into a check image database 900. The processor 810 may retrieve the information about the electronic image file and drawer party identifier from the check image database and automatically determine supplemental information associated with the banking transaction. The processor 810 may then transmit a signal to facilitate a delivery of a pre-paid payment token to a payee party associated with the banking transaction.

The programs 812, 814 may be stored in a compressed, uncompiled and/or encrypted format. The programs 812, 814 may furthermore include other program elements, such as an operating system, a database management system, and/or device drivers used by the processor 810 to interface with peripheral devices.

As used herein, information may be “received” by or “transmitted” to, for example: (i) the banking transaction server 800 from another device; or (ii) a software application or module within the banking transaction server 800 from another software application, module, or any other source.

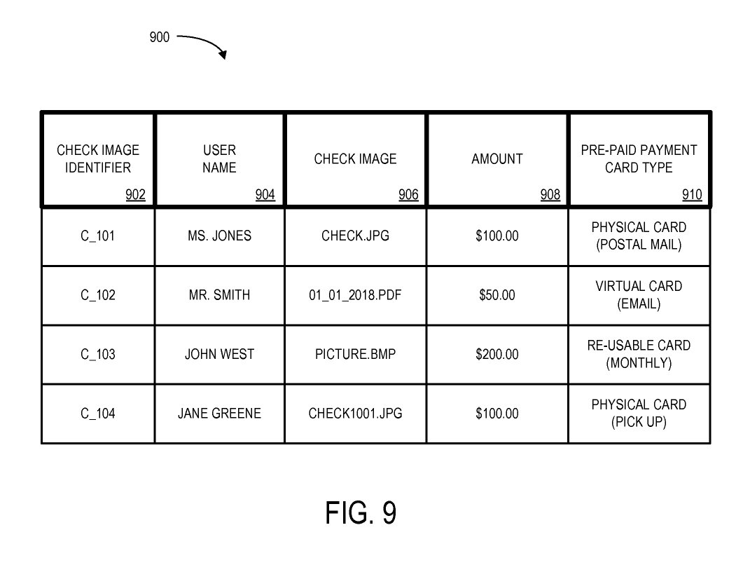

In some embodiments (such as shown in FIG. 8), the storage device 830 further stores a check image database 900, a payment account database 860, and a transaction history database 870. One example of a database that may be used in connection with the banking transaction server 800 will now be described in detail with respect to FIG. 9. Note that the database described herein is only an example, and additional and/or different information may actually be stored therein. Moreover, various databases might be split or combined in accordance with any of the embodiments described herein. For example, the check image database 900 and/or the payment account database 860 might be combined, co-located, and/or linked to each other within the banking transaction server 800.

Referring to FIG. 9, a table is shown that represents the check image database 900 that may be stored at the banking transaction server 800 according to some embodiments. The table may include, for example, entries identifying transactions that have been, or are being, processed (e.g., to create pre-paid debit cards). The table may also define fields 902, 904, 906, 908, 910 for each of the entries. The fields 902, 904, 906, 908, 910 may, according to some embodiments, specify: a check image identifier 902, a user name 904, a check image 906, an amount 908, and a pre-paid card type 910. The check image database 900 may be created and updated, for example, based on information electrically received from remote drawer party devices.

The check image identifier 902 may be, for example, a unique alphanumeric code identifying a banking transaction that involves the user name 904 (e.g., his or her legal name) as the drawer party. The check image 906 might comprise a file or pointer associated with a graphical image file of a check document. The amount 908 might represent the funds associated with the banking transaction, and the pre-paid payment card type 910 could indicate, for example, a physical card, a virtual card, a method of delivery, etc. Note that other information might also be stored in the check image database 900, such as a check date, a payee party name or account identifier, a PAN, an expiration date, a CVC, etc.

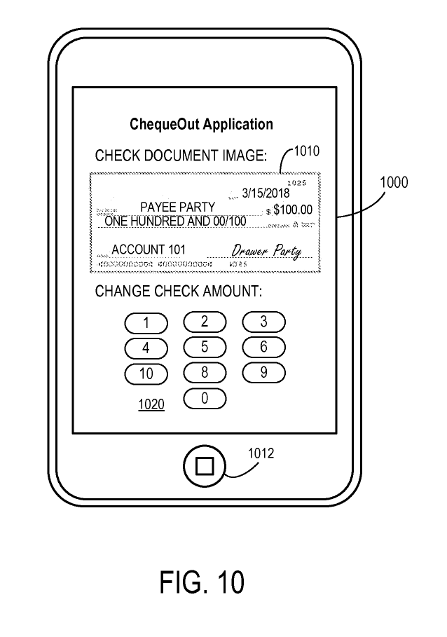

FIG. 10 illustrates a smartphone ChequeOut application display 1000 according to some embodiments. The display 1000 might, for example, run on the user's smartphone and allow the user to capture an image 1010 of a check document. The smartphone may include a fingerprint scanner 1012 to verify the identity of the user. An application running on the smartphone may then execute a transmission process to automatically send the image to a remote ChequeOut server. The display 1000 may further include an area 1020 including a keypad that can be used by the user to adjust a check amount, date, payee, etc.

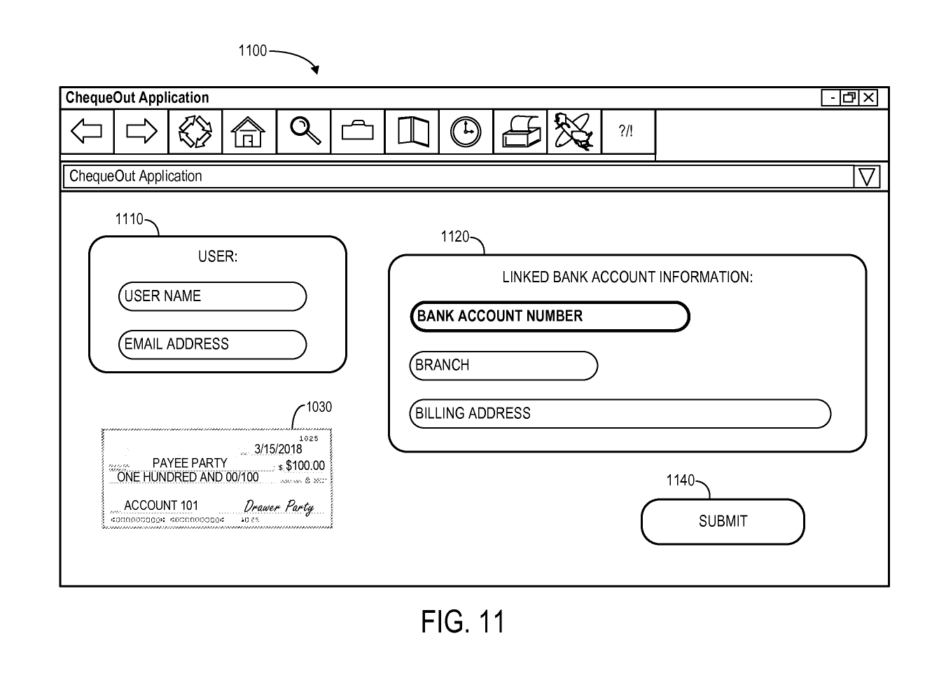

FIG. 11 illustrates a ChequeOut portal display 1100 that might be provided in accordance with some embodiments. The portal display 1100 may include, for example, a first area 1110 where a user may define or alter a name associated with a ChequeOut account, an email address associated with the drawer party, etc. The portal display 1100 may further include a second area 1120 where a user may define or alter one or more payment accounts associated with the application (e.g., a bank account number, branch, billing address, etc.). The display 1100 may also include an image 1030 of a check document that has been, or is being, converted into a pre-paid payment card. Selection of a “Submit” icon 1140 may apply any changes to his or her account and/or initiate a creation of a pre-paid payment card.

Thus, according to some embodiments, an improved banking transaction server might automatically let a person use funds from his or her checking account to create a pre-paid debit card. Moreover, the person can do so without visiting a merchant, he or she may feel comfortable that the process is secure, etc. Moreover, although some embodiments have been described herein as using an electronic image file of a check document from a drawer party identifier, note that other embodiments may be implemented. For example, some embodiments might involve a flow in which a user manually enters bank account information to arrange for a debit. In such embodiments, the user might not need to prepare a check at all. The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A system to provide a pre-paid payment tokens to payee parties, comprising:
(a) a communication unit programmed to:
(i) receive, from a remote drawer party device, an electronic image file associated with a check document and a drawer party identifier, and
(ii) store information about the electronic image file into a check image database;
(b) the check image database storing, for each of a plurality of banking transactions, information about the electronic image file and the drawer party identifier; and
(c) a banking transaction server, coupled to the check image database, programmed to:
(iii) retrieve, from the check image database, the information about the electronic image file and drawer party identifier,
(iv) automatically determine supplemental information associated with the banking transaction, and
(v) transmit a signal to facilitate a delivery of a pre-paid payment token to a payee party associated with the banking transaction.

2. The system of claim 1, wherein the remote drawer party device is associated with at least one of: a smartphone, a camera, a scanner, a web camera, a facsimile machine, and a copier.

3. The system of claim 1, wherein the automatically determined supplemental information includes at least one of: a drawer party postal address, a drawer party bank account number, a check amount, a check date, a check description, a payee party name, a payee party postal address, a payee party electronic message address, a payee party bank account number, a payment type, and a payment delivery type.

4. The system of claim 1, wherein the pre-paid payment token is associated with at least one of: a physical pre-paid payment card mailed to a payee party postal address, a physical pre-paid payment card picked-up by the payee party, and a physical pre-paid payment card delivered to a payee party postal address via a delivery service.

5. The system of claim 4, wherein the banking transaction server associates at least one of the following with the physical pre-paid payment token: a primary account number, an expiration date, and a card security code.

6. The system of claim 1, wherein the pre-paid payment token is associated with at least one of: a virtual pre-paid payment card delivered via a payment portal, and a virtual pre-paid payment card delivered via an electronic message.

7. The system of claim 6, wherein the banking transaction server associates at least one of the following with the physical pre-paid payment token: a primary account number, an expiration date, and a card security code.

8. The system of claim 1, wherein the payee party is the drawer party.

9. The system of claim 1, wherein the banking transaction server is programmed to:
transmit signals to facilitate delivery of pre-paid payment tokens to the payee party on a periodic basis.

10. The system of claim 9, wherein at least one of the pre-paid payment tokens comprise a re-usable pre-paid payment card.

11. A computer-implemented method to provide a pre-paid payment tokens to payee parties, comprising:
receiving, from a remote drawer party device, an electronic image file associated with a check document and a drawer party identifier;
storing information about the electronic image file into a check image database, the check image database storing, for each of a plurality of banking transactions, information about the electronic image file and the drawer party identifier;
retrieving, by a banking transaction server from the check image database, the information about the electronic image file and drawer party identifier;
automatically determining, by the banking transaction server, supplemental information associated with the banking transaction; and
transmitting, by the banking transaction server, a signal to facilitate a delivery of a pre-paid payment token to a payee party associated with the banking transaction.

12. The method of claim 11, wherein the remote drawer party device is associated with at least one of: a smartphone, a camera, a scanner, a web camera, a facsimile machine, and a copier.

13. The method of claim 11, wherein the automatically determined supplemental information includes at least one of: a drawer party postal address, a drawer party bank account number, a check amount, a check date, a check description, a payee party name, a payee party postal address, a payee party electronic message address, a payee party bank account number, a payment type, and a payment delivery type.

14. The method of claim 11, wherein the pre-paid payment token is associated with at least one of: a physical pre-paid payment card mailed to a payee party postal address, a physical pre-paid payment card picked-up by the payee party, and a physical pre-paid payment card delivered to a payee party postal address via a delivery service.

15. The method of claim 14, wherein the banking transaction server associates at least one of the following with the physical pre-paid payment token: a primary account number, an expiration date, and a card security code.

16. The method of claim 11, wherein the pre-paid payment token is associated with at least one of: a virtual pre-paid payment card delivered via a payment portal, and a virtual pre-paid payment card delivered via an electronic message.

17. The method of claim 16, wherein the banking transaction server associates at least one of the following with the physical pre-paid payment token: a primary account number, an expiration date, and a card security code.

18. The method of claim 11, wherein the payee party is the drawer party.

19. The method of claim 11, further comprising:
transmitting, by the banking transaction server, signals to facilitate delivery of pre-paid payment tokens to the payee party on a periodic basis.

20. The method of claim 19, wherein at least one of the pre-paid payment tokens comprise a re-usable pre-paid payment card.
